(19) United States
(12) Patent Application Publication
(10) Pub. No.: US 2012/0129974 A1
(43) Pub. Date: May 24, 2012

(54) AQUEOUS COATING COMPOSITIONS

(75) Inventors: Hugo T. DeNotta, Buenos Aires (AR); Chia-Chen Lo, Kansas, MO (US); Jose L. Verona, Santa Fe (AR)

(73) Assignee: Arkema Inc., Philadelphia, PA (US)

(21) Appl. No.: 13/126,593

(22) PCT Filed: Oct. 26, 2009
(86) PCT No.: PCT/US2009/005804

§ 371 Date: Sep. 14, 2011

Related U.S. Application Data
(60) Provisional application No. 61/197,547, filed on Oct. 28, 2008.

(51) Int. Cl. C09D 133/10; C09D 191/06; C09D 133/16; C09D 131/02

(52) U.S. Cl. 523/221; 524/524; 524/520

(57) ABSTRACT

The disclosure relates to aqueous coating compositions and elastomeric coatings formed from the aqueous coating compositions, and in particular to aqueous coating compositions that can be used to form elastomeric coatings with improved dirt pickup resistance and elastomeric properties.

### TECHNICAL FIELD

The disclosure relates to aqueous coating compositions, elastomeric coatings formed from the aqueous coating compositions, and methods for forming an elastomeric coating having improved dirt pick up resistance characteristics using the aqueous coating composition.

### BACKGROUND

Developing a coating with better dirt pickup resistance continues to be an important goal in the coatings industry. Reasons for this include the industries growth in “softer” elastomeric wall and roof coatings; the industries demand for low-volatile organic compound (VOC) formulations, which traditionally result in tackier coatings due to reduced glass transition temperatures (Tg); and the planned construction of high-rise commercial buildings in emerging geographies, most notably in Asia, which is driving the need for coatings that are easier to clean and maintain.

One approach to improving dirt pickup resistance of coatings has been to create a harder finish by raising the glass transition temperature (Tg) of the coating. There are, however, down sides to this approach. First, it is nonviable in elastomeric applications, such as elastomeric roof coatings, that require elongation and flexibility, since the increased Tg can decrease the flexibility of the coating. Such a decrease in flexibility can lead to the formation of cracks in the coating. Second, increasing the Tg of a coating can require the use of coalescing solvents, which typically have a high VOC content. The increased VOC is in direct opposition to the need for a decrease in VOCs in coatings due to government regulations.

Other approaches to improve the dirt pickup resistance of coatings have included using highly crosslinked polymers, which try to provide a low-tack surface that impedes dirt penetration. While this method can provide an effective solution for automotive coating applications, architectural and elastomeric coatings provide unique challenges due to the need to retain elongation, making crosslinked polymers a less viable approach.

Other approaches have been to use higher levels of organic opacifiers in the coating, which results in a harder surface with increased hydrophobicity. While dirt pickup resistance may be improved, the harder coating makes this method ineffective in elastomeric applications. In addition, multi-staged polymers represent a fairly new technology that involves a mixture of polymers with different Tg ranges, resulting in a mix of hard and soft segments. This technology, however, has yet to overcome many of the same issues discussed above, specifically elongation properties. As such, there is a need in the coatings industry for coatings that provide enhanced dirt pickup resistance, while at the same time achieving suitable elastomeric properties in the coatings.

### SUMMARY

Embodiments of the present disclosure include aqueous coating compositions and elastomeric coatings formed from the aqueous coating composition. The aqueous coating compositions of the present disclosure can provide for elastomeric coatings that have, besides other things, highly elastomeric properties while still providing dirt pickup resistance (DPR). Surprisingly, the elastomeric coatings can be formed from the aqueous coating compositions without the need of a coalescing agent and/or a volatile organic compound (VOC).

For the various embodiments, the aqueous coating composition includes a first polymer particle having a first volume average particle diameter and a glass transition temperature (Tg) of −50° C. to −30° C., and a second polymer particle having a second volume average particle diameter and a Tg of 45° C. to 90° C., where a particle diameter ratio of the first volume average particle diameter to the second volume average particle diameter is at least 4:1. For the various embodiments, the particle diameter ratio of the first volume average particle diameter to the second volume average particle diameter is in the range of 4:1 to 6:1.

For the various embodiments, the first and second polymer particles have both a particle size distribution and a weight average molecular weight that are each in a predetermined value range. For the various embodiments, the first volume average particle diameter of the first polymer particle is in the range of 0.33 micrometer to 0.60 micrometer, and the second volume average particle diameter of the second polymer particle is in the range of 0.06 micrometer to 0.09 micrometer. For the various embodiments, the first polymer particle and the second polymer particle each have a weight average molecular weight that provide that each has a polydispersity index of no greater than 1.11.

For the various embodiments, at least 75 volume percent of the first and second polymer particles are the first polymer particle on a dry basis. For the various embodiments, the combination of the volume average particle diameter and particle diameter ratio of the first and second polymer particles allows for a percolation threshold volume (Vp) to be obtained when the aqueous coating compositions has at least 75 volume percent of the first polymer particle on a dry basis of the aqueous coating composition. While not wishing to be bound by theory, it is believed that for the various embodiments, achieving the percolation threshold volume for the particle diameter ratio allows for the second polymer particles (the smaller of the two particles) to preferentially percolate through the first polymer particles to an outer surface of the elastomeric coating where they can help to form a hard and rough skin layer that improves dirt pick up resistance of the elastomeric coating.

Embodiments of the present disclosure can further include that the first polymer particle and the second polymer particle each include a hydrophobic branched monomer in polymerized form. For example, each of the first polymer particle and the second polymer particle can be formed by a free radical polymerization process prepared with a hydrophobic branched monomer. For the various embodiments, a seed polymerization process can be used to better ensure that the volume average particle diameter, the polydispersity index and the average particle size distribution of the first and second polymer particles are achieved. Examples of the hydrophobic branched monomer in the first polymer particle can include, but are not limited to, isodecyl methacrylate (TDMA). For the various embodiments, the hydrophobic branched monomer in the second polymer particle can include vinyl neodecanoate (NEO 10). Examples of the hydrophobic branched monomer in the second polymer particle can include 2,2,2 trifluoromethacrylate.

Embodiments of the present disclosure further can include an elastomeric coating having a binder formed from the aqueous coating composition of the present disclosure. For the various embodiments, the binder formed from the aqueous coating composition can include the first polymer particle having a first volume average particle diameter, and the second polymer particle having a second volume average particle diameter, the first volume average particle diameter to the second average particle diameter having a particle diameter ratio of at least 4:1, where the second polymer particle percolates to an outer surface of the elastomeric coating to improve dirt pick up resistance of the elastomeric coating.

For the various embodiments, the aqueous coating composition can be used neat to form the elastomeric coating. In other words, the aqueous coating composition does not require any additional components, solvents and/or coalescent aids in order to form the elastomeric coating of the present disclosure. For the various embodiments, the elastomeric coating formed with the aqueous coating composition can provide an elongation value of 450 percent to 1000 percent determined according to ASTM D2370. For the various embodiments, the elastomeric coating formed with the aqueous coating composition can provide a vapor transmission of 5 to 9 grams/m² day determined according to ASTM F1249 or TAPPI 448. For the various embodiments, the elastomeric coating formed with the aqueous coating composition can provide a water absorption of 9.5 percent or less. For the various embodiments, the elastomeric coating formed with the aqueous coating composition can provide a contact angle of at least 142 degrees determined according to ASTM D7334.

For the various embodiments, the aqueous coating composition can include additional components, as discussed herein, to provide the elastomeric coating of the present disclosure. For the various embodiments, when additional components are included with the aqueous coating composition, the first polymer particle and the second polymer particle can serve as a binder for the aqueous coating composition.

The aqueous coating compositions can include a pigment at a pigment volume concentration (PVC) of 20 percent to 48 percent. For the various embodiments, the aqueous coating compositions contain neither a coalescing agent nor a VOC. Even without a coalescing agent, the aqueous coating compositions of the present disclosure have minimum film forming temperature (MFFT) of −20° C. or below.

Embodiments of the present disclosure further include a method to improve dirt pick up resistance characteristics of an elastomeric coating by using the aqueous coating composition of the present disclosure to form the elastomeric coating. For the various embodiments, the aqueous coating compositions can be applied and dried on a substrate to provide an elastomeric coating with suitable elastomeric properties while still providing dirt pickup resistance as compared to coatings formed with aqueous coating compositions not having the first and second polymer particles of the present disclosure. For example, a method for forming an elastomeric coating having suitable elastomeric properties while still providing dirt pickup resistance can include applying to a substrate the aqueous coating composition of the present disclosure and drying the aqueous coating composition on the substrate to form the elastomeric coating. For the various embodiments, drying can comprise air drying in ambient conditions, or it can comprise actively drying the aqueous coating composition by utilizing technology known for accelerating the drying process.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DEFINITIONS

As used herein, “a,” “an,” “the,” “at least one,” and “one or more” are used interchangeably. The terms “comprises” and variations thereof do not have a limiting meaning where these terms appear in the description and claims. Thus, for example, an aqueous coating composition that includes “a” pigment can be interpreted to mean that the pigment includes “one or more” pigments.

The term “and/or” means one, one or more, or all of the listed elements.

Also herein, the recitations of numerical ranges by endpoints include all numbers subsumed in that range (e.g., 1 to 5 includes 1, 1.5, 2, 2.75, 3, 3.80, 4, 5, etc.).

As used herein, the term “dry” means a substantial absence of liquids.

As used herein, the term “substrate” means an underlying layer or surface that may or may not have a coating.

As used herein, the term “coalescing agent” refers to an additive that improves particle coalescence and/or facilitates the formation of coherent films from compositions that include a polymer latex by temporarily plasticizing (e.g., softening) the vehicle system.

As used herein, the term “elastomeric properties” refers to the ability of a coating to elastically stretch and recover over a desired temperature range without disrupting the integrity of the coating.

As used herein, the term “dry weight” refers to a weight of a dry material. For example, the solids content of the aqueous coating composition can be expressed as a dry weight, meaning that it is the weight of the aqueous coating composition remaining after essentially all liquid materials have been removed.

As used herein, the term “particle” refers to at least one of a discrete particle in an aqueous composition, where latex is an example of a dispersion of discrete polymer particles in an aqueous composition.

As used herein, the term “average particle size distribution” refers to a list of values or a mathematical function that defines the relative amounts of particles present in the aqueous composition, where the distribution is sorted according to a volume average particle diameter of the particles.

As used herein, the term “polydispersity” refers to a standard deviation of the average particle size distribution, and is given as a percentage value (e.g., a percent polydispersity is calculated by dividing the mean square deviation by the average diameter of small particles). Small particles can be monodisperse or polydisperse in size. For the case of a polydisperse system dₛ is the average diameter of small particles dₛ=Σnᵢdᵢ/Σnᵢ where nᵢ is the number density of particles with diameter dᵢ. The mean square deviation can be calculated by the following equation: σ=[Σ(dᵢ−dₛ)²nᵢ/Σnᵢ]^{1/2}, where polydispersity P is calculated using the following equation: P=σ/dₛ.

As used herein, “surfactant” refers to an agent that can lower the interfacial tension between a polymer and water and also stabilize polymer particles during the polymerization process.

As used herein, “%” is a symbol for percent, where % and percent can be used interchangeably herein.

As used herein, the term “polydispersity index (PDI)” refers to a measure of the distribution of molecular mass in a given polymer sample, and is calculated by dividing the weight average molecular weight by the number average molecular weight (PDI=Mw/Mn). The PDI has a value always greater than 1, but as the polymer chains approach uniform chain length, the PDI approaches unity (1).

As used herein, the term “critical micelle concentration” refers to the concentration of a surfactant, or surfactants, above which micelles are spontaneously formed.

As used herein, the term “contact angle” refers to the angle produced by a surface of a coating and a tangent along a surface of a liquid drop in the region of the contact point of the liquid drop with the surface of the coating. A contact angle of 0° defines complete wettability, where the liquid does not form a drop. A contact angle of greater than 0° but less than or equal to 90° defines partial wetting, and a contact angle of greater than 90° defines a hydrophobic surface. A contact angle greater than 140° or 150° defines a super hydrophobic surface.

As used herein, the term “dirt pickup resistance” refers to the ability of a coating to resist the adhesion of dirt that contacts the coating so that the coating better maintains its original appearance prior to being exposed to the dirt.

As used herein, “room temperature” refers to an ambient temperature of 20° C. to 25° C.

For the purposes of the present disclosure, the term “copolymer” means a polymer derived from more than one species of monomer.

As used herein, “Tg” is an abbreviation for glass transition temperature, which means the temperature at or above which a glassy polymer will undergo segmental motion of the polymer chain. The T_{g} of the first polymer particle and the second polymer particle reported herein are measured by differential scanning calorimetry.

As used herein, “° C.” is an abbreviation for degrees Celsius.

As used herein, “K” is an abbreviation for degrees Kelvin.

As used herein, “L” is an abbreviation for Liter.

As used herein, “mL” is an abbreviation for milliliter.

As used herein, “mm” is an abbreviation for millimeter.

As used herein, “g” is an abbreviation for gram(s).

As used herein, “alkyl” refers to a hydrocarbon group having the general formula CₙH₂ₙ₊₁, where n is the number of carbon atoms.

As used herein, “PVC” is an abbreviation for pigment volume concentration, which can be calculated by the following formula: PVC (%)=(volume of pigment(s)/(volume of pigment(s)+volume of dry polymer))×100.

As used herein, the terms “elongation” and “tensile strength” are defined and tested according to ASTM D2370.

As used herein, the term “vapor transmission” is defined and tested according to ASTM F1249 or TAPPI 448.

As used herein, “MFFT” is an abbreviation for minimum film forming temperature, which is defined and tested according to ASTM D2354.

As used herein, the term “aqueous emulsion polymer” means a water dispersed polymer formed during a polymerization reaction carried out in an aqueous phase with monomers in an emulsified form (dispersed phase).

As used herein, “VOC” is an abbreviation for volatile organic compound, which is defined as a volatile compound of carbon, excluding methane, carbon monoxide, carbon dioxide, carbonic acid, metallic carbides or carbonates, ammonium carbonate, and exempt compounds according to the Environmental Protection Agency and under, for example, 40 Code of Federal Regulations §51.100(s).

As used herein, the term “aqueous coating composition” is interpreted to mean liquid water containing the first and second polymer particles as described in the present disclosure as dissolved or suspended solids, as well as colloidal dispersions, suspensions, emulsions (such as an aqueous emulsion polymer) and/or latexes as they are defined, where the aqueous coating composition is applied to a substrate.

For the various embodiments, when the “aqueous coating composition” is dried, it is referred to as an “elastomeric coating.”

For the various embodiments a volume average particle diameter for the first polymer particles and the second polymer particles is determined using measurements from a Nanotrac® 150 (Microtrac, Inc.) Dynamic Light Scattering device, where the measurement are taken on a 1 weight percent aqueous suspension of the particles in distilled water.

### BRIEF DESCRIPTION OF DRAWINGS

FIG. 1 is a graph illustrating a percolation threshold volume Vp as a function of particle diameter ratio according to the present disclosure.

FIG. 2 is an SEM image of a coating formed with an aqueous coating composition having a particle diameter ratio of 1.11:1 and the percolation threshold of 57% according to the present disclosure.

FIG. 3 is an SEM image of an elastomeric coating formed with an aqueous coating composition having a particle diameter ratio of 4:1 and a percolation threshold of 25% according to the present disclosure.

FIG. 4 provides images of coatings after a Soiling Test according to the present disclosure.

FIG. 5 provides a picture of a drop of water on an elastomeric coating according to the present disclosure.

### DETAILED DESCRIPTION

The present disclosure provides embodiments of aqueous coating compositions and elastomeric coatings formed from the aqueous coating compositions, which have highly elastomeric properties while still providing dirt pickup resistance (DPR). For the various embodiments, the aqueous coating compositions of the present disclosure include a first polymer particle and a second polymer particle each having a volume average particle diameter (e.g., a relative particle size) and a glass transition temperature (e.g., a hardness) relationship that helps to achieve a desirable balance of these beneficial properties.

For the various embodiments, the first and second polymer particles in the aqueous coating composition each have a volume average particle diameter with a narrow average particle size distribution and a glass transition temperature (“Tg”) in a predetermined relationship that allows for the elastomeric coating formed there from to have highly elastomeric properties and dirt pickup resistance. Surprisingly, the aqueous coating composition used to form this elastomeric coating requires neither a coalescing agent containing a volatile organic compound (VOC) nor a VOC from other sources. For the various embodiments, the aqueous coating compositions of the present disclosure do not contain a coalescing agent and/or a VOC.

In addition to displaying these beneficial properties without the need of a coalescing agent (or a VOC), the aqueous coating composition of the present disclosure also provides for elastomeric coatings that have low vapor transmission and high hydrophobic behavior. These properties allow for elastomeric coatings that are particularly well suited for use on masonry, concrete surfaces, and stone surfaces, among others as discussed herein.

According to the present disclosure, the aqueous coating compositions include a first polymer particle and a second polymer particle, where the first and second polymer particles have a predetermined relationship of both a glass transition temperature (Tg) and a particle diameter ratio. For the various embodiments, the first polymer particle has a Tg of −50° C. to −30° C. For the various embodiments, the first polymer particle has a Tg of −40° C. to −30° C. For the various embodiments, the second polymer particle has a Tg of 45° C. to 90° C. For the various embodiments, the second polymer particle has a Tg of 70° C. to 90° C. For the various embodiments, the first and second polymer particles can be referred to, respectively, as a “soft polymer” particle and a “hard polymer” particle, where these terms are relative to each other.

For the various embodiments, the first polymer particle has a first volume average particle diameter and the second polymer particle have a second volume average particle diameter. For the present embodiments, the shape of the first and second polymer particles in the aqueous composition is taken to be spherical, such as a regular sphere. For the various embodiments, the first volume average particle diameter is in the range of 0.33 micrometers to 0.60 micrometers, and the second volume average particle diameter is in the range of 0.06 micrometers to 0.09 micrometers, when in the aqueous coating composition. The volume average particle diameter of the first and second particles is determined based on spherical geometry using diameter measurements from a Nanotrac® 150 (Microtrac, Inc) Dynamic Light Scattering device, where the measurement are taken on a 1 weight percent aqueous suspension of the particles in distilled water.

For the various embodiments, the first polymer particles used to prepare the aqueous coating composition can have a weight average molecular weight, Mw, of at least 650,000. For the various embodiments, the first polymer particles used to prepare the aqueous coating composition can have a weight average molecular weight, Mw, of at least 700,000. For the various embodiments, the first polymer particles used to prepare the aqueous coating composition can have a weight average molecular weight, Mw, of at least 750,000. For the various embodiments, the first polymer particles used to prepare the aqueous coating composition can have a number average molecular weight, Mn, of at least 590,000. For the various embodiments, the first polymer particles used to prepare the aqueous coating composition can have a number average molecular weight, Mn, of at least 640,000. For the various embodiments, the first polymer particles used to prepare the aqueous coating composition can have a number average molecular weight, Mn, of at least 700,000.

For the various embodiments, the second polymer particles used to prepare the aqueous coating composition can have a weight average molecular weight, Mw, of at least 435,000. For the various embodiments, the second polymer particles used to prepare the aqueous coating composition can have a weight average molecular weight, Mw, of at least 500,000. For the various embodiments, the second polymer particles used to prepare the aqueous coating composition can have a weight average molecular weight, Mw, of at least 540,000. For the various embodiments, the second polymer particles can have a number average molecular weight, Mn, of at least 390,000. For the various embodiments, the second polymer particles can have a number average molecular weight, Mn, of at least 460,000. For the various embodiments, the second polymer particles can have a number average molecular weight, Mn, of at least 500,000. Both the weight average and the number average molecular weights for the first and second polymer particles are measured using gel permeation chromatography.

As appreciated, the ratio of the weight average to the number average molecular weight gives a value for a polydispersity index (PDI) of the polymer particles, where a PDI close to 1 indicates a fairly uniform polymer chain length. For the various embodiments, each of the first polymer particles and the second polymer particles can have a PDI that is close to 1 (approaching a monodispersion). For the various embodiments, the first polymer particle and the second polymer particle each have a weight average molecular weight that provide for a polydispersity index of no greater than 1.11. For the various embodiments, the first polymer particles used to prepare the aqueous coating composition can have a PDI of no greater than 1.10. For the various embodiments, the first polymer particles used to prepare the aqueous coating composition can have a PDI of no greater than 1.09. For the various embodiments, the first polymer particles used to prepare the aqueous coating composition can have a PDI of no greater than 1.08. For the various embodiments, the second polymer particles used to prepare the aqueous coating composition can have a PDI of no greater than 1.11. For the various embodiments, the second polymer particles used to prepare the aqueous coating composition can have a PDI of no greater than 1.09. For the various embodiments, the second polymer particles used to prepare the aqueous coating composition can have a PDI of no greater than 1.08. PDI was measured using diameter measurements from a Nanotrac® 150 (Microtrac, Inc) Dynamic Light Scattering device, where the measurement were taken on a 1 weight percent aqueous suspension of the particles in distilled water.

As a result, the various embodiments of the present disclosure provide that each of the first and second polymer particles in the aqueous coating composition can have an average particle size distribution that is very narrow. In other words, the average particle size distribution for each of the first and second volume average particle diameters has a polydispersity (e.g., a standard deviation of the average particle size distribution) that is very small. For example, the polydispersity for the first polymer particle can be 5 percent or less, while the polydispersity for the second polymer particle can be 7 percent or less. As a result, the aqueous coating composition can have essentially a bimodal particle size distribution, or a binary mixture, of the first and second polymer particles.

For the various embodiments, this bimodal distribution, or binary mixture, of the first and second polymer particles allows for a particle diameter ratio of the particles in the aqueous coating composition. For the various embodiments, the first volume average particle diameter and the second volume average particle diameter are provided in the aqueous coating composition in the particle diameter ratio, where a particle diameter ratio of the first volume average particle diameter to the second volume average particle diameter is at least 4:1. For the various embodiments, the particle diameter ratio of the first volume average particle diameter to the second volume average particle diameter is in the range of 4:1 to 6:1.

For the various embodiments, the bimodal distribution and the particle diameter ratio of the first and second polymer particles has been found to have an influence on how the polymer particles segregate during the formation of the elastomeric coating. As appreciated, a system of particles in motion (such as the first and second polymer particles in the aqueous coating composition as the elastomeric coating is forming) distributes itself through a variety of mechanisms, including what is known as percolation. During percolation, different size particles of the system can migrate in different directions depending upon a number of different factors. These factors can include the relative size and weight of the particles as well as a percolation temperature at which the percolation is occurring. As a result of this migration, the different size particles can segregate themselves to different parts of the elastomeric coating.

For the various embodiments, the particle diameter ratio (with its bimodal distribution) and the weight average molecular weight of the first and second polymer particles, among other things, is believed to affect the segregation of the polymer particles as the elastomeric coating forms. In particular, a percolation threshold volume (Vp) has been identified from these parameters that provide a volume percentage of the second polymer particle (the relatively smaller hard polymer particle as compared to the first polymer particle) needed to cause the second polymer particles to preferentially segregate to an outer surface of the elastomeric coating during the drying process. In this relative position, the second polymer particles can help to form a hard and rough layer that is both hydrophobic and that helps to improve dirt pickup resistance, while the first polymer particle helps to balance and control the elastomeric behavior of the elastomeric coating. For the various embodiments, the percolation threshold volume (Vp) can be obtained with aqueous coating compositions having at least 75 volume percent of the first polymer particle on a dry basis of the aqueous coating composition. For the various embodiments, the remaining volume percent of the aqueous coating composition can be the second polymer particle. For the various embodiments, a percolation temperature for the percolation threshold volume (Vp) is in the range of 5° C. to 40° C.

It is appreciated, however, that there is not necessarily a complete segregation of the first and second polymer particles as the elastomeric coating forms. For the various embodiments, the hard and rough layer of the elastomeric coating can include a blend of the first and second polymer particles. Such blends, however, will typically include a majority of the second polymer particle when the volume percentage of the second polymer particle is within the percolation threshold volume (Vp). In other words, the percolation threshold volume (Vp) of the present disclosure can be used to better ensure that the bimodal system of the first and second polymer particles will preferentially segregate so that the majority of the hard and rough layer is formed with the second polymer particles.

Examples of such blends for the hard and rough layer formed when the second polymer particle is within the percolation threshold volume (Vp) include from 16 to 25 volume percent of the second polymer particles and from 75 to 84 volume percent of the first polymer particle on a dry basis of the aqueous coating composition. Surprisingly, these volume percentages of the first and second polymer particles in the hard and rough layer provide for improved dirt pickup resistance, while the polymer particles supporting the hard and rough layer provide for the elastomeric coatings highly elastic properties. Even more surprisingly, it has also been found that when the volume percentage of the second polymer particle is within the percolation threshold volume (Vp) the aqueous coating composition does not require a coalescing agent or a VOC in order to form the elastomeric coating.

For the various embodiments, the morphological structure of the hard and rough layer also contributes to the elastomeric coatings ability to provide dirt pickup resistance (DPR). As illustrated in the Examples section below, the hard and rough layer of the elastomeric coating includes a topography having projections or bumps that provide for a “rough” surface. One skilled in the art will appreciate that the presence of a relatively high degree of surface roughness can provide for at least two important contact effects between the rough surface and materials that can come into contact with the rough surface. First, the existence of a high degree of surface roughness can provide for a very small contact area between the surface and a contaminant (e.g., a particulate or an aqueous liquid droplet) that can come into contact with the surface. As such, adhesion between the contaminant and the surface can be minimized due to the minimal contact area between the two. Second, the surface roughness can facilitate the trapping of air beneath a portion of the contaminant. For instance, when considering a liquid droplet coming into contact with the rough surface, an air boundary layer can form between portions of the droplet and the surface; this air boundary layer can increase the contact angle between the droplet and the surface.

Although surface roughness can provide a surface with some degree of hydrophobicity, hydrophobicity can be further enhanced when combined with a surface chemistry providing a low surface energy. The hard and rough layer of the elastomeric coating also displays a low surface energy, which coupled with the rough surface, leads to a high contact angle which resists wetting and adherence of dirt and contaminants. Thus, when a solid particulate or a liquid droplet, (e.g., a water droplet) contacts the coating, it can roll or slide off of the surface due to the combined effects of surface roughness and low surface energy. Also, when considering a liquid droplet, as the droplet rolls down the surface and encounters a solid particle on the surface, the particle can adhere to the passing droplet and can simultaneously be removed from the surface with the liquid, as adhesion between the surface and the particle has been minimized, as described herein. Thus, the particle can preferentially adhere to the liquid and be “cleaned” from the surface of the elastomeric coating.

Surprisingly, it has been discovered that if a coalescent agent were to be used with the aqueous coating composition of the present disclosure, the resulting hard and rough layer structure is altered to a smoother surface relative the hard and rough surface formed without the use of the coalescing agent. As such, for the various embodiments the aqueous costing composition of the present disclosure does not contain, use and/or include a coalescing agent and/or a VOC.

As discussed herein, a surface is considered to be hydrophobic if the contact angle of a droplet of water is greater than 90°. For the various embodiments, elastomeric coatings formed with the aqueous coating composition of the present disclosure can have contact angles of 120° to greater than 140°. For the various embodiments, the properties of the aqueous coating compositions (rheology, solids content, etc.) are suitable for application with many known application techniques. Furthermore, the aqueous coating compositions of the present disclosure do not require further process steps once they are applied to a substrate.

As will be appreciated, known emulsion polymerization techniques that can be used to control the size of the polymer particle, such as suspension polymerization, preferentially including seed polymerization, and dispersion polymerization, and the like can be used to control the polymer particle size. As appreciated, the type of surfactant(s) (low CMC, reactive surfactant(s), etc) and the polymerization process, among others, used with the emulsion polymerization technique can have an influence on the size of the polymer particle. The size and polydispersity of the polymer particles (e.g., the particle diameter) can be controlled by the choice of polymerization starting materials and conditions for each of the first and second polymer particles, such as a seed size and concentration, polymerization rate, catalyst or initiator concentration, reaction temperature, surfactant concentration, and the like.

For the various embodiments, a seed polymerization can be used to achieve the recited profiles of PDI, average particle size distribution and polydispersity for the first and second polymer particles. For example, a first seed having an average particle size of 0.15 microns and a polydispersity of 5 percent or lower can be used at a level in the range of 0.24 to 0.28 parts on weight based on 100 weight percent of monomers for the first polymer particle. For the various embodiments, a second seed having an average particle size of 0.035 microns and a polydispersity of 6 percent or lower can be in the range of 15.1 to 16 parts on weight based on 100 weight percent of monomers for the second polymer particle.

For the various embodiments, the first polymer particle and the second polymer particle can each be prepared by an emulsion polymerization of at least one hydrophobic ethylenically unsaturated monomer. For the various embodiments, the composition of each of the first and second polymer particles includes from 90 percent to 99.9 percent by weight based on the total weight of the polymer. Examples of such hydrophobic ethylenically unsaturated monomers include, but are not limited to, highly branched monomers having at least 8 carbon atoms and/or fluorinated monomers.

For the various embodiments, the highly branched monomers can include, but are not limited to, highly branched neo vinyl esters. Suitable highly branched neo vinyl esters typically contain from 8 to 18 carbon atoms and are prepared from suitable highly branched carboxylic acids by methods known in the art. Commercially available neo vinyl ester products are normally a mixture containing a predominance of one species. Suitable neo vinyl ester compositions for use in the present disclosure can include, but are not limited to, vinyl neononanoate, vinyl neodecanoate, vinyl neododecanoate, and vinyl esters of mixed branched carboxylic acids, vinyl esters of mixed 10 to 13 carbon atom branched carboxylic acid, isodecyl methacrylate, and the like. Suitable fluorinated monomers can include, but are not limited to, fluoroolefins such as chlorotrifluoroethylene and tetrafluoroethylene, perfluoro (propylene vinyl ether), perfluoro (methyl vinyl ether), perfluoro (ethyl vinyl ether), hexafluoropropylene (HFP), 2,2,2,trifluoroethyl methacrylate, and the like. Mixtures of the highly branched monomers and/or the fluorinated monomers can be employed.

In addition to the at least one hydrophobic ethylenically unsaturated monomer, each of the first and second polymer particles can be formed with (e.g., each include in polymerized form) at least one hydrophilic functional monomer. For the various embodiments, the amount of the hydrophilic functional monomers incorporated into the first and second polymer particles of the present disclosure is in the range of 10 percent to 0.1 percent by weight based on the total weight of the polymer.

Examples of hydrophilic functional monomers useful in forming the first and second polymer particles can include, but are not limited to, hydrophilic functional monomers that contain ethylenically unsaturated double bonds for free radical reaction with the hydrophobic ethylenically unsaturated monomer or other monomers during polymerization. Examples of such hydrophilic functional monomers can include, but are not limited to, acrylic acid, methacrylic acid, n-butyl acrylate, isobutyl acrylate, isopropyl acrylate, ethyl acrylate, methyl acrylate, 2-ethylhexyl acrylate, 2-ethylhexyl methacrylate, methyl methacrylate, ethyl methacrylate, n-butyl methacrylate, pentyl acrylate, and mixtures thereof.

Other hydrophilic functional monomers which may be used in the preparation of the first and second polymer particles can include, but are not limited to: vinyl esters, for example, vinyl acetate, vinyl propionate, vinyl formate, vinyl n-butyrate, and the like; vinyl ethers, for example, methylvinyl ether, ethylvinyl ether, butylvinyl ether, and the like; allyl monomers, for example, allyl acetate, allyl propionate, allyl lactate, allyl amines, and the like; olefins, such as ethylene, propylene, 1-butene, 1-pentene, 1-hexene, and the like. Other vinyl monomers, functional monomers, and cross linking monomers, for example, acrylamide, methacrylamide, diacetone acrylamide (DAAM), N-methylol acrylamide, N-methylol methacrylamide, hydroxyethyl methacrylate, hydroxypropyl methacrylate, 2,2,4-trimethyl-1,3-pentanediol monomethacrylate, 2-cyanoethyl acrylate, diethylaminoethyl acrylate, dimethylaminoethyl methacrylate, glycidyl acrylate, glycidyl methacrylate, acetoacetoxyethyl methacrylate, allyl methacrylate, trimethylol propane trimethacrylate, methoxyethyl acrylate, p-carboxyethyl acrylate, ethylene methacrylate phosphate, maleic acid, fumaric acid, itaconic acid, dimethyl maleate, diethyl maleate, diethylhexyl maleate, diethyl fumarate, 1,4-butanediol dimethacrylate, diallyl maleate, crotonic acid, mixtures thereof, and the like.

Glass transition temperatures of the polymer particles can be calculated using the Fox Equation (T. G. Fox, Bull. Am. Physics Soc., Volume 1, Issue No. 3, page 123 (1956)), where calculating the Tg of a copolymer of, for example, monomers M1, M2 and M3:

1/Tg(calc.)=w(M1)/Tg(M1)+w(M2)/Tg(M2)+w(M3)/Tg(M3)

where Tg(calc.) is the glass transition temperature calculated for the copolymer, w(M1) is the weight fraction of monomer M1 in the copolymer, w(M2) is the weight fraction of monomer M2 in the copolymer, w(M3) is the weight fraction of monomer M3 in the copolymer, Tg(M1) is the glass transition temperature of the homopolymer of M1, Tg(M2) is the glass transition temperature of the homopolymer of M2, and Tg(M3) is the glass transition temperature of the homopolymer of M3 all temperatures being in K. Tg values for monomers and/or homopolymers may be found, for example, in “Polymer Handbook”, edited by J. Brandrup, E. H. Immergut and E. A. Grulke, Wiley-Interscience Publishers 4^{th} Edition. As appreciated, a variety of monomers and amounts of the monomers, as discussed herein, can be selected to form each of the first and second polymer particles so as to achieve the desired Tg value and/or range for the polymer particle.

For the various embodiments, monomers used in forming the first polymer particle can include isodecyl methacrylate (IDMA). For the various embodiments, monomers used in forming the first polymer particle can include mixtures of 2-ethyl hexyl acrylate, vinyl neodecanoate (NEO 10), and methyl methacrylate that contain no more than 10 percent by weight of NEO 10 and no more than 3 percent by weight of methyl methacrylate, with the remaining monomer being 2-ethyl hexyl acrylate, n-butyl acrylate or a combination thereof. For example, for the various embodiments the first polymer particle can include in polymerized form 5 percent to 10 percent, by weight, of NEO 10, 3 percent or less, by weight, of a methyl methacrylate monomer, with the remaining monomer being 2-ethyl hexyl acrylate, n-butyl acrylate or a combination thereof.

For the various embodiments, the first polymer particle can include in polymerized form (e.g., can be formed with) 97 to 98.3 percent by weight of isodecyl methacrylate (IDMA); from 0 to 2.0 weight percent of acrylic acid; and from 0 to 2.06 percent by weight of acrylamide. For the various embodiments, the first polymer particle can include in polymerized form 97.3 to 98 percent by weight of isodecyl methacrylate; from 0 to 1.8 weight percent of acrylic acid; and from 0 to 1.8 percent by weight of acrylamide. For the various embodiments, the first polymer particle can include in polymerized form 97.5 to 97.8 percent by weight of isodecyl methacrylate; from 0 to 1.4 weight percent of acrylic acid; and from 0 to 1.7 percent by weight of acrylamide.

For the various embodiments, monomers used in forming the second polymer particle can include 2,2,2,trifluoroethyl methacrylate. For the various embodiments, monomers used in forming the second polymer particle can include mixtures of 2-ethyl hexyl acrylate, vinyl neodecanoate (NEO 10), and methyl methacrylate that contain no more than 10 percent by weight of NEO 10 and no more than 3 percent by weight of methyl methacrylate, with the remaining monomer being 2-ethyl hexyl acrylate, n-butyl acrylate or a combination thereof.

For the various embodiments, the second polymer particle can include in polymerized form (e.g., can be formed with) 94 to 98.5 percent by weight of 2,2,2,trifluoroethyl methacrylate; from 0 to 2.0 weight percent of acrylic acid; and from 0 to 2.0 percent by weight of acrylamide. For the various embodiments, the second polymer particle can include in polymerized form 94.3 to 98.3 percent by weight of 2,2,2,trifluoroethyl methacrylate; from 0 to 1.8 weight percent of acrylic acid; and from 0 to 1.8 percent by weight of acrylamide. For the various embodiments, the second polymer particle can include in polymerized form 94.4 to 98.3 percent by weight of 2,2,2,trifluoroethyl methacrylate; from 0 to 1.4 weight percent of acrylic acid; and from 0 to 1.4 percent by weight of acrylamide.

Suitable polymerization conditions may be used. Typically, the reaction temperature is in the range of 0° C. to 100° C. The polymerization can be conducted using polymerization initiators. Suitable free radical polymerization initiators are the initiators known to promote emulsion polymerization and can include water-soluble oxidizing agents, such as organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.), and those initiators that are activated in the water phase by a water-soluble reducing agent. Such initiators are employed in an amount sufficient to cause polymerization. The amount of such free radical initiators used can be in the range of 0.05 percent to 6 percent by weight based on the weight of all monomers present.

For the various embodiments, redox initiators may be employed, especially when polymerization is carried out at lower temperatures. For example, reducing agents may be used in addition to the persulfate and peroxide initiators mentioned above. Typical reducing agents can include, but are not limited to, alkali metal salts of hydrosulfites, sulfoxylates, thiosulfates, sulfites, bisulfites, reducing sugars such as glucose, sorbose, ascorbic acid, erythorbic acid, and the like. In general, the reducing agents are used in the range of 0.01 percent to 5 percent by weight based on the weight of all monomers present.

Various additives can be added before, during, or after polymerization. These can include surfactants, reactive surfactants, radical generating agents, buffering agents, neutralizing agents, chelating agents, plasticizers, defoamers, chain-transfer agents, plasticizers, emulsifying agents, polymeric stabilizers, among others. Suitable surfactants can include, but are not limited to, those having a low critical micelle concentration (CMC). For the various embodiments, suitable surfactants have a CMC of less than 0.009 g/100 g in 0.1M NaCl at 25° C. So, for the various embodiments the first polymer particle can include a surfactant having a critical micelle concentration of less than 0.009 g/100 g in 0.1M NaCl at 25° C. For the various embodiments, the use of reactive surfactants during the polymerization is also possible.

Examples of suitable surfactants can include DOWFAX™2A1 (The Dow Chemical Company), RHODAFAC™ RF-610D (Rhodia), ADEKA™ R-1025 (Adeka), HITENOL™ BC-20 AND HITENOL™BC-1025 (Dai-Ichi Kogyo Seiyaku Co.). For the various embodiments, the amount of the surfactant can be in the range of 0 percent to 3 percent by weight. For the various embodiments, the amount of the surfactant can be in the range of 0 percent to 2.8 percent by weight. For the various embodiments, a wax emulsion can be used in the formation of the second polymer particle, including Michem® Lube 511 (an anionic paraffin/polyethylene wax emulsion from Michelman). So, for the various embodiments the second polymer particle can include an anionic paraffin/polyethylene wax emulsion.

The first and second polymer particles of the present disclosure are obtained from the emulsion polymerization as latex polymers in an aqueous composition. Useful aqueous compositions containing either the first polymer particle or the second polymer particle will typically have a solids content from 42 percent to 55 percent by weight based on the total weight of the composition. The polymer particles of the present disclosure may be tailored to obtain the desired Tg, molecular weight, and viscosity. The pH, of an aqueous composition containing the polymer particles will normally be in the range of 2 to 12.

The manner of combining the polymerization ingredients for the production of each of the first and second polymer particles can be by various known monomer feed methods, such as continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

For the various embodiments, the aqueous coating composition can be used as a binder in a coating formulation. For example, for the various embodiments the aqueous coating composition can be used as a binder in a paint formulation. For the various embodiments, the paint formulation can be prepared according to a number of known manufacturing methods. Generally, such methods involve the preparation of the aqueous coating composition (in this case the binder), mixing of the additional ingredients, dispersing of the pigments, and adjusting the density and viscosity to desired levels. A variety of additives and diluents which are known in the art can be mixed in the paint formulation to achieve certain properties in the paint formulation and/or the elastomeric coating. The additives can include, but are not limited to, surfactants, defoamers, thickeners, rheology modifiers, coalescents, biocides, mildewcides, surfactants, and other additives known in the art.

For the various embodiments, a paint formulation of the present disclosure can be prepared without the use of either a coalescing agent or a VOC (Volatile Organic Compound). For the various embodiments, the paint formulation of the present disclosure is prepared without the use of either a coalescing agent or a VOC. For the various embodiments, the paint formulation having the aqueous coating composition can include a pigment volume concentration (PVC) of 20% to 48%. For the various embodiments, the paint formulation can be a “semi-gloss paint,” which has a relatively low PVC. For the various embodiments, the paint formulation can be a “satin paint,” which has a relatively high PVC. For the various embodiments, the paint formulation can be a “flat paint,” which has a relatively high PVC compared to satin paint.

Suitable pigments can include carbon black; titanium dioxide; iron pigments such as solid iron oxide; antimony oxide pigments; zinc oxide, barium pigments; calcium pigments; zirconium pigments; chromium pigments; magnesium pigments; zinc sulfide; lithopone, phthalo blue, and plastic pigments such as solid bead and microsphere pigments containing voids or vesicles. The aqueous coating composition may also contain other ingredients including extenders such as silica, talc, mica, calcium carbonate, feldspar, aragonite, calcite, dolomite, magnesium hydroxide, magnesium carbonate, magnesite, satin white, alumina trihydrate, clay, kaolin clay, calcined clay, diatomaceous earth, vaterite, magadiite, and combinations thereof. The pigments and/or the other ingredients used in the aqueous coating composition can be hydrophobic and/or are treated so as to be more hydrophobic as compared to their un-treated condition.

The aqueous coating composition can include thickeners and/or rheology modifiers to modify the rheology and flow of the aqueous coating composition. The aqueous coating composition can include dyes; preservatives including biocides, mildewcides and fungicides; plasticizers; adhesion promoters; antifoaming agents; dispersing agents, emulsifiers, buffers, neutralizers, freeze-thaw additives, wet-edge aids, humectants, UV absorbers such as benzophenone, substituted benzophenones, and substituted acetophenones; colorants, waxes, and/or anti-oxidants, and combinations thereof.

For the various embodiments, aqueous coating compositions that include the aqueous emulsion polymer can be prepared by a number of different techniques. For example, when the aqueous coating composition is pigmented, at least one pigment can be dispersed in the aqueous coating composition under high shear using a high speed mixer, such as a COWLES mixer or, in the alternative, at least one predispersed pigment may be used. Other techniques are also possible.

The following are non-limiting examples of paint formulations that use the aqueous coating composition of the present disclosure as the binder. For the various embodiments, the paint formulation can have from 0.2 to 0.5 weight percent of a dispersant (e.g., Tamol™ 165, Rohm & Haas), from 0.10 to 0.25 weight percent of a surfactant (e.g., Triton™ CF 100, The Dow Chemical Company), from 0.05 to 0.15 weight percent of an antifoam (e.g., TEGO® Foamex 8020, Evonik Tego Chemie), from 17 to 22 weight percent of a pigment (e.g., Ti-Pure® R-706, DuPont E. I. de Nemours & Co.), from 7 to 12 weight percent of a first extender (Sibelite® M 3000, SCR-Sibelco), from 4 to 7 weight percent of a second extender (e.g., Lithosperse® 7005, J.M. Huber Corporation), from 0.40 to 0.60 weight percent of a thickener (e.g., CELLOSIZE™ HEC ER-30,000, The Dow Chemical Company), from 34 to 45 weight percent of the aqueous coating composition of the present disclosure used as the binder, from 0.03 to 0.07 weight percent of a preservative (e.g., Kathon™ LX 14%, Rohm and Haas Co.), and from 0.02 to 0.06 weight percent of a biocide (e.g., 2 N-Octyl-4-isothiazolin-3-one (OIT), Rohm and Haas Co.). For the various embodiments, water can be used to achieve 100 weight percent for the paint formulation.

For the various embodiments, the paint formulation can have from 0.3 to 0.45 weight percent of a dispersant (e.g., Tamol™ 165, Rohm & Haas), from 0.15 to 0.25 weight percent of a surfactant (e.g., Triton™ CF 100, The Dow Chemical Company), from 0.05 to 0.15 weight percent of an antifoam (e.g., TEGO® Foamex 8020, Evonik Tego Chemie), from 18 to 22 weight percent of a pigment (e.g., Ti-Pure® R-706, DuPont E. I. de Nemours & Co.), from 8 to 12 weight percent of a first extender (Sibelite® M 3000, SCR-Sibelco), from 5 to 7 weight percent of a second extender (e.g., Lithosperse® 7005, J.M. Huber Corporation), from 0.45 to 0.60 weight percent of a thickener (e.g., CELLOSIZE™ HEC ER-30,000, The Dow Chemical Company), from 37 to 45 weight percent of the aqueous coating composition of the present disclosure used as the binder, from 0.04 to 0.07 weight percent of a preservative (e.g., Kathon™ LX 14%, Rohm and Haas Co.), and from 0.03 to 0.06 weight percent of a biocide (e.g., 2 N-Octyl-4-isothiazolin-3-one (OIT), Rohm and Haas Co.). For the various embodiments, water can be used to achieve 100 weight percent for the paint formulation.

For the various embodiments, the paint formulation can have from 0.3 to 0.35 weight percent of a dispersant (e.g., Tamol™ 165, Rohm & Haas), from 0.15 to 0.18 weight percent of a surfactant (e.g., Triton™ CF 100, The Dow Chemical Company), from 0.05 to 0.10 weight percent of an antifoam (e.g., TEGO® Foamex 8020, Evonik Tego Chemie), from 18 to 20 weight percent of a pigment (e.g., Ti-Pure® R-706, DuPont E. I. de Nemours & Co.), from 10 to 12 weight percent of a first extender (Sibelite® M 3000, SCR-Sibelco), from 5 to 6 weight percent of a second extender (e.g., Lithosperse® 7005, J.M. Huber Corporation), from 0.50 to 0.60 weight percent of a thickener (e.g., CELLOSIZE™ HEC ER-30,000, The Dow Chemical Company), from 38 to 45 weight percent of the aqueous coating composition of the present disclosure used as the binder, from 0.05 to 0.07 weight percent of a preservative (e.g., Kathon™ LX 14%, Rohm and Haas Co.), and from 0.04 to 0.06 weight percent of a biocide (e.g., 2 N-Octyl-4-isothiazolin-3-one (OIT), Rohm and Haas Co.). Other formulations are also possible where the aqueous coating composition of the present disclosure is used as the binder for the paint. For the various embodiments, water can be used to achieve 100 weight percent for the paint formulation.

For the various embodiments, the paint formulation can be prepared in a two step process: the grind and the letdown. During the grind, solvent (water), dispersant, surfactant, antifoam, pigment, preservative, biocide, extenders, and thickener, among other components, can be mixed together. During the letdown, the binder is added to the grind product, where more of the thickener can be used to modify the rheology and flow of the paint formulation.

For the various embodiments, the aqueous coating composition of the present disclosure can be useful in applications where elastomeric coatings having improved mechanical, elastomeric, adhesion and hydrophobic properties are desired, such as elastomeric wall coatings, elastomeric roof coatings, architectural coatings, industrial and automotive coatings, sealants, adhesives, textile applications, and the like.

The aqueous coating composition may be advantageously applied to substrates such as, for example, natural elastomers, synthetic elastomers, polymers, metal, metal oxides, glass, cloth, ceramic, clay, fiber, concrete, brick, rock, cinder block, paper, film, carpet, curtains, marble, granite, wallpaper, grout, mortar, drywall, spackling, plaster, adobe, stucco, unglazed tile, glazed tile, unglazed porcelain, glazed porcelain, cardboard, primed surfaces, painted surfaces, weathered surfaces, wood, cementations substrates, and the like. The aqueous coating composition may be applied to a surface as a primer layer. Drying of the aqueous coating composition once applied to the substrate is typically allowed to proceed under ambient conditions such as, for example, at 0° C. to 35° C., which includes room temperature as defined herein.

The aqueous coating compositions can be applied onto the surface of a substrate by various application methods including spraying methods such as, for example, air-atomized spray, air-assisted spray, airless spray, high volume low pressure spray, and air-assisted airless spray; rolling; dipping; brushing; curtain coating; and drawdown applicators. The amount of the aqueous coating composition applied onto a substrate may vary widely with the type of substrate. For example, the amount applied to a concrete substrate may depend upon the type of concrete, the porosity of the concrete and the extent of weathering of the concrete. Further, the aqueous coating composition may be absorbed into the concrete and may fill the pores of the concrete. Suitable application does not require the formation of a continuous coating of the aqueous coating composition on the substrate. The aqueous coating composition may be applied as a single application or as multiple applications.

After application of the aqueous coating composition onto a substrate, the aqueous coating composition is dried or is allowed to dry to form the elastomeric coating. The substrate including the aqueous coating composition may be dried by the application of heat or hot air to remove the water. For the various embodiments, the aqueous coating composition applied onto a substrate may be allowed to dry to form the elastomeric coating at ambient conditions such as a temperature in the range of 10° C. to 50° C. and relative humidity in the range of 0 to 99 percent. Typical drying times at ambient condition may be in the range of 90 minutes to 96 hours.

For the various embodiments, the aqueous coating composition of the present disclosure can be used for treating non-porous and porous substrate surfaces such as automotive and household materials including wheels, wheel trim, wheel covers, removable wheel covers, splash guards, car panels and painted surfaces, clear-coated car surfaces, metal, painted metal fixtures, chromed articles, bumpers, bumper stickers, bug deflectors, rain deflectors, vinyl materials including car boots, wheel covers, convertible tops, camper awnings, sun shades, vehicle covers, license plates, plastic articles, lens covers, signal light lens covering, brake light lens covering, headlamp and fog light lens, vinyl, rubber, leather surfaces, dashboard, dash instrument lens covering, seats, carpet, and floor runners.

Embodiments of the present disclosure are illustrated by the following examples. It is to be understood that the particular examples, materials, amounts, and procedures are to be interpreted broadly in accordance with the scope and spirit of the disclosure as set forth herein.

### EXAMPLES

The following examples are given to illustrate, but not limit, the scope of this disclosure. Unless otherwise indicated, all parts and percentages are by weight. Unless otherwise specified, all instruments and chemicals used are commercially available.

### Materials

### Monomers

Isodecyl Methacrylate (“IDMA”) monomer available from Evonik.

Acrylic acid available from Nalco.

Acrylamide available from SNF Inc.

2,2,2,trifluoroethyl methacrylate available from Tosoh USA Inc.

NEO 10 branched vinyl ester available from Resolution Performance Products.

Methylmethacrylate (“MMA”) available from BASF.

### Surfactants, Dispersants and Antifoams

DOWFAX™ 2A1 available from The Dow Chemical Company.

RHODAFAC™ RE-610D available from Rhodia Inc.

ADEKA™ R-1025 available from Adeka USA Corporation.

HITENOL™ BC-20 available from Dai-Ichi Kogyo Seiyaku Co.

HITENOL™ BC-1025 available from Dai-Ichi Kogyo Seiyaku Co.

Triton™ CF 100 available from The Dow Chemical Company.

Tamol™ 165 available from Rohm and Haas Co.

AEROSOL A-102 available from Cytec Industries, Inc.

Tego® Foamex 8020 available from Evonik Tego Chemie.

### Seed for Emulsion Polymerization

UCAR™ Latex DA 3105 available from The Dow Chemical Company.

UCAR™ Latex 626 available from The Dow Chemical Company.

Latex SL-3000 available from The Dow Chemical Company.

### Polymerization Initiators, Oxidants

Sodium Persulfate available from FMC Corporation.

Sodium Methabisulfite available from Univar USA Inc.

Tert-butyl Hydroperoxide (TBHP) available from Lyondell Chemical Company Inc.

### Binders Pigments, Extenders and Other Additives

MICHEM® Lube 511 available from Michelman, Inc.

RHOPLEX™ 2438 available from Rhom and Haas.

UCAR® Latex DA 3176 A available from The Dow Chemical Company.

Tergitol™ NP-100 available from The Dow Chemical Company.

Kathon™ LX 14% available from Rohm and Haas Co.

Drewplus® L-108 available from Ashland.

Nytal® 300 available from V.T. Vanderbilt Company Inc.

Huber® 80C available from the J.M. Huber Corporation.

Ti-Pure® R-706, Ti-Pure® R-902, and Ti-Pure® R-931 available from DuPont E. I. de Nemours & Co.

Sibelite® M 3000 available from SCR-Sibelco.

Lithosperse® 7005 available from J.M. Huber Corporation.

CELLOSIZE™ HEC ER-30,000 available from The Dow Chemical Company. 2 N-Octyl-4-isothiazolin-3-one (OIT) available from Rohm and Haas Co.

2-EHA available from BASF.

### Example 1

In this Example, study the percolation threshold volume, Vp, as a function of the particle diameter ratio. As discussed herein, the percolation threshold volume, Vp, provides a volume percentage of the second polymer particle (the relatively smaller hard polymer particle as compared to the first polymer particle) needed to cause the second polymer particles to preferentially segregate to an outer surface of the elastomeric coating during the drying process. The particle diameter ratio refers to the proportional amount or relative magnitude of the volume average particle diameter for the first polymer particle relative the volume average particle diameter for the second polymer particle. As discussed herein, the bimodal distribution and the particle diameter ratio of the first and second polymer particles has been found to have an influence on how the polymer particles segregate during the formation of the elastomeric coating.

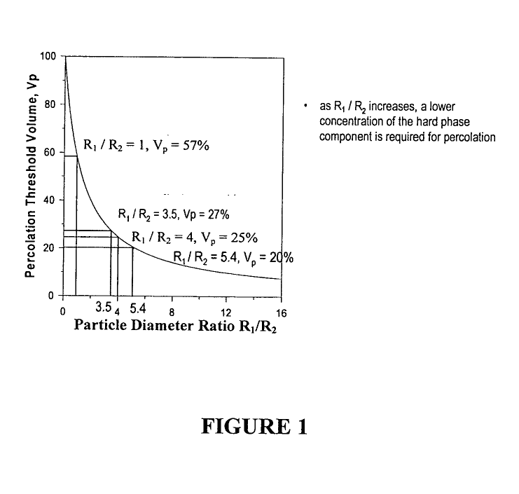

The percolation threshold volume Vp, as defined herein, is determined by mathematical calculations, the results of which are plotted on FIG. 1. Continuum Percolation Thresholds for mixtures of spheres of different sizes (R. Consiglio, D. R. Baker, G. Paul & H. E Stanley; Physica A: Statistical Mechanics and its Applications, Volume 319, 1 Mar. 2003, Pages 49-55) and Introduction of the Percolation Theory (Dietrich Stauffer and Amnon Aharony; Taylor & Francis, London Revised Second Edition 1994) were used to conduct the mathematical calculations.

As shown in FIG. 1, as the particle diameter ratio increases, the percolation threshold volume, Vp, decreases. As a result, a lower concentration of the second polymer particle is required to achieve the percolation threshold volume Vp. For the various embodiments, improvements in the dirt pickup resistance and other properties of the elastomeric coating are also observed as the particle diameter ratio increases. As discussed herein, values for the particle diameter ratio that provide for the percolation threshold volume, Vp, as well as dirt pickup resistance and elongation properties for the elastomeric coating include those where the first volume average particle diameter to the second volume average particle diameter have a particle diameter ratio in the range of 4:1 to 6:1. Particle diameter ratio values above 6:1 have been found to cause sedimentation of the first polymer particle in the aqueous coating composition over time.

From the data provided in FIG. 1, prepare aqueous coating compositions of the first and second polymer particles at percolation threshold volumes of 57% and 25%. For the aqueous coating compositions with the percolation threshold volumes of 57%, the first polymer particle has a PDI of 1.09, a Tg of −30° C., a Mw of 720,000, and a volume average particle diameter of 0.1 microns. The second polymer particle has a PDI of 1.08, a Tg of 70° C., a Mw of 480,000, and a volume average particle diameter of 0.09 microns. The volume average particle diameters for the first and second polymer particles allows for aqueous coating compositions having particle diameter ratios of 1.11:1 to achieve the percolation threshold volume of 57%. The volume average particle diameter of the first and second particles is determined based on spherical geometry using diameter measurements from a Nanotrac® 150 (Microtrac, Inc) Dynamic Light Scattering device, where the measurement are taken on a 1 weight percent aqueous suspension of the particles in distilled water.

For the aqueous coating compositions with the percolation threshold volumes of 25%, the first polymer particle has a PDI of 1.08, a Tg of −30° C., a Mw of 730,000, and a volume average particle diameter of 0.36 microns. The second polymer particle has a PDI of 1.08, a Tg of 70° C., a Mw of 480,000, and a volume average particle diameter of 0.09 microns. The volume average particle diameters for the first and second polymer particles allows for aqueous coating compositions having particle diameter ratios of 4:1 to achieve the percolation threshold volume of 25%. The volume average particle diameter of the first and second particles is determined based on spherical geometry using diameter measurements from a Nanotrac® 150 (Microtrac, Inc) Dynamic Light Scattering device, where the measurement are taken on a 1 weight percent aqueous suspension of the particles in distilled water.

For each of the aqueous coating compositions, mix 75 volume percent of the first polymer particle and 25 volume percent of the second polymer particle, on a dry basis of the aqueous coating composition, in a Heidolph ST1 agitator at 200 RPM for 15 minutes at a temperature 25° C. Allow the composition to rest 24 hours before preparing the elastomeric coating. Form an elastomeric coating with each of the aqueous coating compositions by applying a 0.007 inch (7 mils) thick coat of the aqueous coating composition to a Leneta P121-10N chart (Leneta Company) using a U-shaped draw down bar from Byk-Gardner (USA). Allow the aqueous coating composition to dry at a temperature 25° C. and a controlled relative humidity of 50% for 24 hours to form the elastomeric coating. Sputter coat each of the elastomeric coatings and view each of the elastomeric coatings under a scanning electron microscope (Hitachi S2400 manufactured by Hitachi Instruments Inc.).

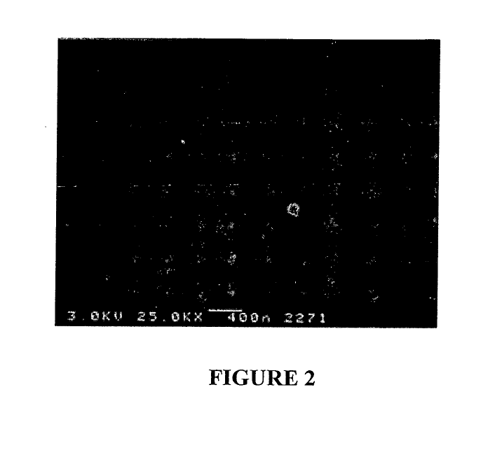

FIG. 2 provides an SEM image of the elastomeric coating formed with the aqueous coating composition described above having the particle diameter ratio of 1.11:1 and the percolation threshold of 57%. As shown in FIG. 2, the second polymer particles (the hard polymer) are present at the skin layer in about the same proportion as in the polymer particles supporting the skin layer, in direct proportion to their concentration. This would be expected from random packing of compatible latexes having similar particle sizes (particle diameter ratio almost equal to 1). Percolation according to the present disclosure was not seen in this aqueous coating composition.

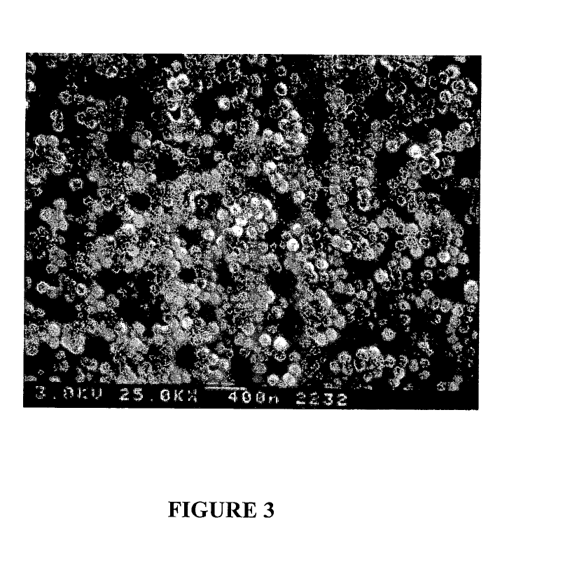

In contrast, FIG. 3 provides an SEM image of an elastomeric coating formed with the aqueous coating composition having a particle diameter ratio of 4:1 and a percolation threshold of 25%. As shown in FIG. 3, the second polymer particles have preferentially segregate to the outer surface of the elastomeric coating during the drying process. As discussed herein, the preferential segregation of the second polymer particles is believed to be due to percolation as discussed herein. In this relative position, the second polymer particles can help to form the hard and rough layer of the elastomeric coating that is both hydrophobic and that helps to improve dirt pickup resistance, while the first polymer particle helps to balance and control the elastomeric behavior of the elastomeric coating.

### Example 2

In this Example, study a bending resistance of the elastomeric coatings as a function of the Tg values for the first polymer particle and the second polymer particle used in the aqueous coating compositions. In particular, vary the Tg of the first polymer particle while holding the Tg of the second polymer particle constant for the aqueous coating compositions.

Prepare the aqueous coating compositions of the first and second polymer particles at a percolation threshold volume of 25%, which corresponds to a particle diameter ratio of 4:1. For this example, the first polymer particle has a PDI of 1.08, a Mw of 730,000, a volume average particle diameter of 0.36, and Tg values starting with −10° C. and following with −20° C., −30° C., and −40° C. The second polymer particle has a PDI of 1.08, a Mw of 480,000, a volume average particle diameter of 0.09 microns, and a Tg value of 70° C. The Tg value for the first and second polymer particles are determined by differential scanning calorimetry using a DSC Q 1000 from TA Instruments. For the test, condition samples with a temperature cycle up to 120° C., maintain the sample at 120° C. for two minutes, cool to −90° C., and scan at 10° C./min. The inflection point of the curve was assigned as the Tg for the polymer particle.

For each of the aqueous coating compositions, mix 75 volume percent of the first polymer particle and 25 volume percent of the second polymer particle, on a dry basis of the aqueous coating composition, in a Heidolph ST1 agitator. Mix the aqueous coating composition at 200 RPM for 15 minutes at a temperature 25° C. Allow the aqueous coating composition to rest for 24 hours before formulating the elastomeric coating.

Form an elastomeric coating with each of the aqueous coating compositions by forming a 1.2 millimeter (mm) thick coating of the aqueous coating composition on a glass plate with a U-shaped draw down bar from Byk-Gardner. Allow the aqueous coating composition to dry at a temperature 25° C. and a controlled relative humidity of 50% for seven (7) days to form the elastomeric coating. Remove the elastomeric coating from the glass plate and test the bending resistance of each coating according to ASTM D522 Standard Test Methods for Mandrel Bend Test using an Elcometer 1510 conical mandrel bend tester (Elcometer). For the results shown in Table 1a “Pass” means that no cracks were seen in the elastomeric coating after the bending resistance test, and a “No Pass” means that cracks were seen in the elastomeric coating after the bending resistance test. The results are shown below in Table 1.

TABLE 1

| T_{g} (° C.) | T_{g} (° C.) | Elastomeric Coating Bending |
|---|---|---|
| First Polymer | Second Polymer | Resistance |
| particle | particle | (−20° C.) |
| −40 | 70 | Pass |
| −30 | 70 | Pass |
| −20 | 70 | No Pass |
| −10 | 70 | No Pass |

Table 1 shows that as the Tg of the first polymer particle increases, the bending resistance of the elastomeric coating does not pass.

### Example 3

In this Example, study the residual tack and film crack properties of the elastomeric coatings as a function of the Tg values for the first polymer particle and the second polymer particle used in the aqueous coating compositions. In particular, hold the Tg of the first polymer particle constant while varying the Tg of the second polymer particle for the aqueous coating compositions.

Prepare the aqueous coating compositions of the first and second polymer particles at a percolation threshold volume of 25%, which corresponds to a particle diameter ratio of 4:1. For this example, the first polymer particle has a PDI of 1.08, a Mw of 730,000, a volume average particle diameter of 0.36, and a Tg value of −30° C. The second polymer particle has a PDI of 1.08, a Mw of 480,000, a volume average particle diameter of 0.09, and Tg values of 40° C., 45° C., 70° C., and 90° C. The Tg value for the first and second polymer particles are determined by differential scanning calorimetry using a DSC Q 1000 Manufactured by TA Instruments, as previously discussed in Example 2.

For each of the aqueous coating compositions, mix 75 volume percent of the first polymer particle and 25 volume percent of the second polymer particle, on a dry basis of the aqueous coating composition, in a Heidolph ST1 agitator at 200 RPM for 15 minutes at a temperature 25° C. Allow the aqueous coating composition to rest 24 hours before preparing the elastomeric coating. Form an elastomeric coating with each of the aqueous coating compositions by applying a 0.007 inch (7 mils) thick coat of the aqueous coating composition to a Leneta P121-10N chart (Leneta Company) using a U-shaped draw down bar from Byk-Gardner (USA). Allow the aqueous coating composition to dry at a temperature 25° C. and a controlled relative humidity of 50% for 24 hours to form the elastomeric coating.

Test the residual tack of each coating using a Rolling Ball test method according to ASTM D3121. For the test of residual tack, the distance in centimeters the ball rolls determines the presences of residual tack, where distances less than 20 centimeters indicates a coating with an unacceptable tack and distances of 20 centimeters or greater indicate a coating with an acceptable tack or no tack. Use a TT-100 Rolling Ball Track Tester, which meets standards set by the Pressure Sensitive Tape Council (PSTC-6) and the ASTM (ASTM D3121) for testing tack of a film.

Test the film crack properties of each of the elastomeric coatings, where the presences of cracks in the elastomeric coating are determined by visual observation of the elastomeric coatings made according to ASTM D823.

The results for both the residual tack and the film crack properties are shown in Table 2, below.

TABLE 2

| T_{g} (° C.) | T_{g} (° C.) | | |
|---|---|---|---|
| Second Polymer | First Polymer | | |
| particle | particle | Residual tack | Film Crack |
| 40 | −30 | Yes | No |
| 45 | −30 | Yes | No |
| 70 | −30 | No | No |
| 90 | −30 | No | Yes |

As shown in Table 2, as the Tg of the second polymer particle is increased, the elastomeric coating transitions from having a residual tack (Tg of 40° C. for the second polymer particle) to not having a residual tack at Tg values of 70° C. and greater. However, if the Tg of the second polymer particle is increased to a value of 90° C. or above the elastomeric coating shows film crack.

### Example 4

In this Example, use a Soiling Test to measure dirt pickup resistance of elastomeric coatings formed with an aqueous coating composition having different particle diameter ratios. In addition, also measure an elongation of the elastomeric coatings formed with an aqueous coating composition having different particle diameter ratios.

Prepare aqueous coating compositions of the first and second polymer particles having particle diameter ratios of 3:1, 4:1 and 6:1. For this example, the first polymer particle has a PDI of 1.08, a Tg of −30° C., a Mw of 750,000, and volume average particle diameters of either 0.27, 0.36 or 0.54. The second polymer particle has a PDI of 1.08, a Tg of 70° C., a Mw of 480,000, and volume average particle diameters of 0.09. The volume average particle diameters for the first and second polymer particles allows for aqueous coating compositions having particle diameter ratios of 3:1, 4:1 and 6:1 to achieve the percolation threshold volume of 28%, 25% and 16%, respectively. The volume average particle diameter of the first and second particles is determined based on spherical geometry using diameter measurements from a Nanotrac® 150 (Microtrac, Inc) Dynamic Light Scattering device, where the measurement are taken on a 1 weight percent aqueous suspension of the particles in distilled water.

For each of the aqueous coating compositions, mix 75 volume percent of the first polymer particle and 25 volume percent of the second polymer particle, on a dry basis of the aqueous coating composition, in a Heidolph ST1 agitator at 200 RPM for 15 minutes at a temperature 25° C. Allow the composition to rest 24 hours before preparing the elastomeric coating.

For the Soiling Test, form an elastomeric coating with each of the aqueous coating compositions by applying a 0.007 inch (7 mils) thick coat of the aqueous coating composition to the varnished side of a Leneta Form 2C Opacity Chart (Leneta Company) using a U-shaped draw down bar from Byk-Gardner (USA). Allow the aqueous coating composition to dry at a temperature 25° C. and a controlled relative humidity of 50% for 24 hours to form the elastomeric coating.

Measure and record an initial reflectance of each coating using a Technibrite™ Micro TB-1C (measurement angle of 45° using a 457 nm wavelength). Soil the entire surface of the elastomeric coating with a slurry of iron oxide in water (50% weight/weight slurry of red iron oxide and water). To soil the elastomeric coating, apply the slurry on the elastomeric coating using a brush at a temperature of 25° C. Place the soiled coating in an oven (Blue M Industrial Oven) set to 60° C. for 8 hours. Allow the soiled coating to cool to room temperature. Wash the soiled coating with high pressure water (tap water at room temperature) using an air pistol (Cane NT) working at pressure of 40 PSI and at a distance of 20 to 30 cm from the soiled coating. Dry the washed soiled coating at room temperature and humidity. Repeat this soiling process a total of 5 times.

After the fifth soiling process, measure a final reflectance of the soiled coating using the Technibrite Micro TB-1C at the same setting used to measure the initial reflectance. Using the initial reflectance of the elastomeric coating and the final reflectance of the soiled coating calculate a percent Drop of Reflectance using the following equation:

% Drop of Reflectance=[(Initial reflectance)−(Final Reflectance)/Initial Reflectance]×100.

To test elongation of the elastomeric coatings, form an elastomeric coating with each of the aqueous coating compositions by forming a 1.2 millimeter (mm) thick coating of the aqueous coating composition on a glass plate with a U-shaped draw down bar from Byk-Gardner. Allow the aqueous coating composition to dry at a temperature 25° C. and a controlled relative humidity of 50% for seven (7) days to form the elastomeric coating. Remove the elastomeric coating from the glass plate and measure the elongation of the elastomeric coating according to ASTM D2370 using an Instron 1011 (Instron).

Table 3, below, provides data on the percent Drop in Reflectance for the soiled elastomeric coatings, where the larger the percent Drop in Reflectance the lower the dirt pickup resistance of the elastomeric coating. Table 3 also provides data on the elongation (%) of the elastomeric coatings.

TABLE 3

| Particle Diameter Ratio | Drop in Reflectance (%) | Elongation (%) |
|---|---|---|
| 3:1 | −20% | 197 |
| 4:1 | −16% | 884 |
| 6:1 | −14% | 1252 |

As can be seen from Table 3, the aqueous coating composition having a particle diameter ratio of 6:1 provides an elastomeric coating with a percent Drop in Reflectance and an elongation that is superior to the aqueous coating composition having a particle diameter ratio of 3:1. As discussed herein, for the given Tgs, the particle diameter ratio has an impact on the efficiency of the percolation of the aqueous coating composition. It is believed that particle diameter ratios of less than 4:1 for the aqueous coating composition percolate less efficiently, which results in less of the second polymer particle in the skin layer of the elastomeric coating as compared to ratios of 4:1 or 6:1. This less efficient percolation results in more of the second polymer particle remains below the skin layer of the elastomeric coating, where it causes an increase in the overall Tg of the elastomeric coating below the skin layer. In addition, when more of the second polymer particle is present below the skin layer they may form hard polymer domains that create discontinuities in the elastomeric coating below the skin layer, leading to the negative effect on the elongation of the elastomeric coating as illustrated in Table 3.

### Example 5

In this Example, use the aqueous coating composition as a binder in paint formulations with different pigment volume concentrations (PVC). Test elastomeric coatings formed with the paint formulations for blistering resistance, elongation, dirt pickup resistance, and porosity.

Prepare the aqueous coating composition of the first and second polymer particles at a percolation threshold volume of 25%, which corresponds to a particle diameter ratio of 4:1. For this example, the first polymer particle has a PDI of 1.08, a Mw of 730,000, a volume average particle diameter of 0.36, and a Tg value of −30° C. The second polymer particle has a PDI of 1.08, a Mw of 480,000, a volume average particle diameter of 0.09 microns, and a Tg value of 70° C. Mix 75 volume percent of the first polymer particle and 25 volume percent of the second polymer particle, on a dry basis of the aqueous coating composition, in a Heidolph ST1 agitator. Mix the composition at 200 RPM for 15 minutes at a temperature 25° C. Allow the aqueous coating composition to rest for 24 hours before preparing the paint formulations. The aqueous coating composition has a 51 weight % solids content.

The paint is formulated in two steps. In the first step, a grind is prepared by adding to a 1 Kg glass Beaker 45.13 weight percent of water, 0.15 weight percent of TEGO® Foamex 8020 antifoam, 0.46 weight percent of Tamol™ 165 dispersing agent, 0.23 weight percent of Triton™ CF 100 surfactant and 0.76 weight percent of the CELLOSIZE™ HEC ER-30,000 thickener while mixing at low speed (no more than 20 RPM) with a COWLES mixer for 10 minutes at room temperature.

To prepare the grind, stir at high speed (more than 50 RPM) 30.37 weight percent of Ti-Pure® R-706 titanium dioxide pigment, 15.19 weight percent of Sibelite® M3000 extender and 7.6 weight percent of Lithosphere®7005 extender. After adding the last extender maintain the agitation at high speed by one hour. Finally, add 0.046 weight percent of OIT (Fungicide) and 0.064 weight percent of Kathon LX 14% as bactericide.

In the second step, at a speed of no more than 20 RPM prepare the letdown by adding the aqueous coating composition (used as the binder) on the grind up to obtain three different Pigment Volume Concentrations (PVC) of 20%, 42% and 55%. For a PVC of 20%, blend 40 weight percent of grind with 60 weight percent of the aqueous coating composition. For a PVC of 42%, blend 66 weight percent of grind with 34 weight percent of the aqueous coating composition. For a PVC of 55%, blend 76 weight percent of grind with 24 weight percent of the aqueous coating composition. Mix the resulting paint formulations an additional 10 minutes at 10 RPM of agitator speed. Adjust the pH to 8 using ammonia or other base.

To test blistering resistance of the paint formulations, form a coating with each of the paint formulations by forming a 1.2 millimeter (mm) thick coating of the aqueous coating composition on a glass plate with a U-shaped draw down bar from Byk-Gardner. Allow the aqueous coating composition to dry at a temperature 25° C. and a controlled relative humidity of 50% for seven (7) days to form the elastomeric coating. Remove the elastomeric coating from the glass plate and cut a 5 cm by 5 cm test specimen. Place the specimen in a glass beaker filled with tap water and allow the specimen to soak at room temperature for 96 hours. At 96 hours, remove the test specimen from the tap water and dry the surface of the test specimen with a paper tissue and test the blister resistance according to ASTM D714.

To test elongation of the paint formulations, form a coating with each of the paint formulations as discussed above for the blistering resistance test. Remove the elastomeric coating from the glass plate and measure the elongation of the elastomeric coatings prepared with the different paint formulations according to ASTM D2370 using an Instron 1011.

Measure the Drop of Reflectance for the elastomeric coatings prepared with the paint formulations using the Soiling Test discussed above in Example 4.

To test the porosity of the elastomeric coatings formed from the paint formulations, form a coating with each of the paint formulations by applying a 0.007 inch (7 mils) thick coat of the paint formulation to a Leneta P121-10N chart (Leneta Company) using a U-shaped draw down bar from Byk-Gardner (USA). Allow the paint formulation to dry at a temperature 25° C. and a controlled relative humidity of 50% for 24 hours to form the elastomeric coating. Test the porosity of the elastomeric coatings prepared from the paint formulations according to ASTM D3258.

Table 4 shows the results for blister resistance, elongation, dirt pickup resistance (as measured by Drop in Reflectance), and porosity for coating prepared with the paint formulations.

TABLE 4

| Paint | | | Drop in | Porosity |
|---|---|---|---|---|
| Formulated | Blistering | Elongation | Reflectance | (ASTM |
| at PVC % | Resistance* | (%) | (%) | D3258)** |
| 20 | Poor | 1120 | −17 | Very Low |
| 42 | Good | 981 | −15 | Very Low |
| 55 | Good | 584 | −25 | High |

*Blistering Resistance: Poor means MD (Blister size 2); Good means F (Blister size 8) or less.
**Results are presented as the difference of reflectance of the untested coating and that of the penetrated coating.

For PVC equal to 20%, Very Low means a 3% drop; for PVC equal to 42% Very Low means a 5% drop; and for PVC equal to 55% High means a 27% drop.

As shown in Table 4, elastomeric coatings prepared from the paint formulation having a PVC of 20% have a high elongation, a very low porosity resulting in poor blister resistance and a 17% drop in reflectance after the Soiling Test. Elastomeric coatings prepared from the paint formulation having a PVC of 42% have a lower elongation as compared to the elastomeric coating prepared from the paint formulation having a PVC of 20%, a 17% drop in reflectance after the Soiling Test, a very low porosity, but a good blister resistance. It is believed that a PVC of 42% is very close to the critical pigment volume concentration for the paint formulation as prepared for this example. As understood, the critical pigment volume concentration for paint is the PVC for which the amount of binder (in this case the aqueous coating composition) is the minimum amount necessary to cover all the pigment particles in the paint. Paint formulations prepared with a PVC that is above the critical pigment volume concentration typically show a higher porosity, which provides voids within the elastomeric coating to provide hiding power, blistering resistance, but lower elongation.

### Example 6

In this example, formulate paint formulations having a 42% PVC, as discussed above for Example 5, with different types of titanium dioxide. Test the elastomeric coatings formed from the paint formulations for contact angle and dirt pickup resistance. The different types of titanium dioxide for use in the paint formulations are Ti-Pure® R-902 (DuPont), Ti-Pure® R-931 (DuPont), and Ti-Pure® R-706 (DuPont), where each type of titanium dioxide has a different coating of amorphous silica and alumina at different weight percentages. Of the three titanium dioxides, Ti-Pure® R-706 has a hydrophobic surface treatment.

To test the contact angle, form a coating with each of the paint formulations by applying a 0.007 inch (7 mils) thick coat of the aqueous coating composition to a Leneta P121-10N chart (Leneta Company) using a U-shaped draw down bar from Byk-Gardner. Allow the paint formulation to dry at a temperature 25° C. and a controlled relative humidity of 50% for 24 hours to form the elastomeric coating. Measure contact angles for the elastomeric coatings using a Dataphysics OCA 150 according to ASTM D7334 (Pendant drop method).

To test drop in reflectance, form a coating with each of the paint formulations by applying a 0.007 inch (7 mils) thick coat of the paint formulation to the varnished side of a Leneta Form 2C Opacity Chart (Leneta Company) using a U-shaped draw down bar from Byk-Gardner. Allow the paint formulation to dry at a temperature 25° C. and a controlled relative humidity of 50% for 24 hours to form the elastomeric coating. Drop of Reflectance for the elastomeric coatings prepared with the paint formulations is measured using the Soiling Test discussed above in Example 4.

Table 5 shows the results for the contact angle and the drop of reflectance for the elastomeric coatings prepared with the paint formulations having a 42% PVC and different titanium dioxide.

TABLE 5

| 42% PVC Paint | | Drop in |
|---|---|---|
| Formulated with | Contact Angle [°] | Reflectance (%) |
| Ti Pure ® R-902 | 137 | −19 |
| Ti Pure ® R-931 | 136 | −18 |
| Ti Pure ® R-706 | 146 | −15 |

As shown in Table 5, Ti-Pure® R-706 gives the paint formulation the lowest drop in reflectance and the highest contact angle as compared to the other types of titanium dioxides tested.

### Example 7

In this example, formulate paint formulations having a 42% PVC, as discussed above for Example 5, with different combinations of extenders. Test the elastomeric coatings formed from the paint formulations for contact angle and dirt pickup resistance. The different types of extenders include Sibelite® M 3000, Lithosperse® 7005, Nytal® 300, and Huber® 80C. Sibelite® M 3000 is a silica hydrophobic extender and Lithosperse® 7005 is a clay with a hydrophobic surface treatment. Both extenders have a hydrophobic behavior. On the other hand, Nytal® 300 is a talc that is less hydrophobic than Sibelite® M 3000, and Huber® 80C is a hydrophilic calcium carbonate.

The paints are formulated as described in Example 5, where a first paint formulation includes a first combination of extenders: Sibelite® M 3000 and Lithosperse® 7005 (as is described in Example 5), and a second paint formulation includes a second combination of extenders: Nytal® 300 and Huber® 80C. For the second combination of extenders the paint formulation includes 10 weight percent of Nytal® 300 and 5 weight percent of Huber® 80C.

To test drop in reflectance, form a coating with each of the paint formulations by applying a 0.007 inch (7 mils) thick coat of the paint formulation to the varnished side of a Leneta Form 2C Opacity Chart (Leneta Company) using a U-shaped draw down bar from Byk-Gardner. Allow the paint formulation to dry at a temperature 25° C. and a controlled relative humidity of 50% for 24 hours to form the elastomeric coating. Drop of reflectance for the elastomeric coatings prepared with the paint formulations is measured using the Soiling Test discussed above in Example 4.

To test the contact angle, form a coating with each of the paint formulations by applying a 0.007 inch (7 mils) thick coat of the aqueous coating composition to a Leneta P121-10N chart (Leneta Company) using a U-shaped draw down bar from Byk-Gardner. Allow the paint formulation to dry to at a temperature 25° C. and a controlled relative humidity of 50% for 24 hours form the elastomeric coating. Measure contact angles for the elastomeric coatings using a Dataphysics OCA 150 according to ASTM D7334 (Pendant drop method).

Table 6 shows the results for the contact angle and the drop of reflectance for the elastomeric coatings prepared with the paint formulations having a 42% PVC formulated with different combinations of extenders.

TABLE 6

| 42% PVC Paint formulated with | | Drop in |
|---|---|---|
| Ti-Pure ® R-706 and the | Contact Angle | Reflectance |
| following Extenders | [°] | (%) |
| Sibelite ® M 300/Lithosperse ® 7005 | 148 | −14 |
| Nytal ® 300/Huber ® 80C | 136 | −21 |

As shown in Table 6, the use of the first combination of extenders (Sibelite® M 300 and Lithosperse® 7005) provides for a more hydrophobic coating as compared to the second combination of extenders (Nytal® 300 and Huber® 80C). The lower drop in reflectance showed by the paint formulated with the first combination of extenders also confirms the higher dirt pickup resistance typically seen on rough hydrophobic surfaces.

### Example 8

In this Example, test the water absorption of the first polymer particle formed with different surfactants in an emulsion polymerization. The surfactants include DOWFAX™ 2A1, HITENOL™ BC-20 (a reactive surfactant), and AEROSOL A-102.

For this example, prepare the first polymer particle as a latex in a seeded semi continuous emulsion polymerization process. When DOWFAX™ 2A1 is the surfactant, prepare a monomer pre-emulsion by adding 97.34 parts per hundred parts monomer by weight (PPHM), of the IDMA, 0.6 PPHM of acrylic acid, 2.06 PPHM of acrylamide, 15 PPHM of water and 0.47 PPHM of DOWFAX™ 2A1. When HITENOL™ BC-20 is the surfactant, prepare the monomer pre-emulsion by adding 97.34 PPHM of the IDMA, 0.6 PPHM of acrylic acid, 2.06 PPHM of acrylamide, 15 PPHM of water and 0.8 PPHM of HITENOL™ BC-20. When AEROSOL A-102 is the surfactant, prepare the monomer pre-emulsion by adding 97.34 PPHM of the IDMA, 0.6 PPHM of acrylic acid, 2.06 PPHM of acrylamide, 15 PPHM of water and 1.4 PPHM of AEROSOL A-102. Mix each of the monomer pre-emulsions in a two liters glass beaker (15 cm diameter) with a Heidolph ST1 agitator (10 cm diameter paddle impeller operating at 1400 RPM) at room temperature for one hour.

Charge a jacketed one gallon reactor having a agitator with 58.63 PPHM of water and 0.28 PPHM of a 49.2 percent solids seed latex (UCAR™ Latex 3105) having a volume average particle size of 0.14 microns. Heat the reactor to 78° C.

At a zero time for the reaction, start adding a stream of sodium methabisulfite (0.10 PPHM) and 1.71 PPHM of water as an initial reducer and a stream of sodium persulfate (0.35 PPHM) and 6.8 PPHM of water as a polymerization initiator. At 3 minute from the zero time start adding the monomer pre-emulsion stream. At 184 minutes from the zero time finish adding the monomer pre-emulsion stream. At 195 minutes from the zero time finish adding the initial reducer and the polymerization initiator. From 195 to 205 minutes from the zero time continue to agitate the emulsion product. From 205 to 215 minutes from the zero time start adding the final polymerization oxidizer stream (0.35 PPIIM of TBHP and 2.54 PPHM of water) and the final polymerization reducer stream (0.23 PPHM of sodium methabisulfite and 1.71 PPHM of water). Increase the reactor temperature to 80° C. and allow the reaction to continue from 215 to 250 minutes from the zero time. Following polymerization the reaction is neutralized with ammonia to a final pH of 8.0. Add 0.86 PPHM of Tergitol™ NP-100 with 30 moles of ethylene oxide to the polymerization product as a post addition to provide mechanical and ionic stability.

To test the water absorption for the first polymer particle, form a coating with a coating composition of the first polymer particle. For the coating composition, centrifuge the latex of the first polymer particle at 2,000 RPM for 10 minutes in a Col Parmer 17341 centrifuge to remove air from the latex. Form a 1.2 millimeter (mm) thick coating of the coating composition on a glass plate with a U-shaped draw down bar from Byk-Gardner. Allow the coating composition to dry at a temperature 25° C. and a controlled relative humidity of 50% for seven (7) days to form the coating. Remove the coating from the glass plate and cut a 5 cm by 5 cm test specimen of the coating.

Weigh the test specimen using an analytic balance and record the initial weight in grams. Place the specimen in a glass beaker filled with tap water and allow the specimen to soak at room temperature for 24 hours. At 24 hours, remove the test specimen from the tap water and dry the surface of the test specimen with a paper tissue. Immediately weigh the specimen and record the final weight in grams. Repeat this 24 hour testing procedure and final weight measurements so as to complete 96 hours of soaking in the tap water. Calculate the percent water absorption with the following equation:

% Water Absorption=[(Final Weight−Initial Weight)/Initial Weight]×100

The results for water absorption are shown in Table 7, below.

TABLE 7

| Surfactants used in Emulsion Polymerization of | |
|---|---|
| First Polymer particle | Absorption after 96 hrs. |
| DOWFAX ™ 2A1 | 8% |
| HITENOL ™ BC-20 | 9% |
| AEROSOL A-102 | 15% |

As shown in Table 7, the first polymer particles prepared with the AEROSOL A-102 surfactant had the highest percentage of water absorption after 96 hours. In contrast, the first polymer particles prepared with DOWFAX™ 2A1 had the lowest water absorption after 96 hours. As compared to the other surfactants, DOWFAX™ 2A1 has a very low critical micelle concentration (CMC), which means that it is highly hydrophobic. In contrast, AEROSOL A-102 is hydrophilic (a sodium salt of a sulfosuccinate) and HITENOL™ BC-20 is a reactive surfactant that remains grafted to the polymer particle.

### Example 9

In this Example, prepare aqueous coating compositions with and without a wax aqueous dispersion Michem® Lube 511.

Prepare an aqueous coating composition of the first and second polymer particles at a percolation threshold volume of 25%, which corresponds to a particle diameter ratio of 4:1. For this example, the first polymer particle has a PDI of 1.08, a Mw of 730,000, a volume average particle diameter of 0.36, and a Tg value of −30° C. The second polymer particle has a PDI of 1.08, a Mw of 480,000, a volume average particle diameter of 0.09 microns, and a Tg value of 70° C.

For aqueous coating compositions without Michem® Lube 511, mix 75 volume percent of the first polymer particle and 25 volume percent of the second polymer particle, on a dry basis of the aqueous coating composition, in a Heidolph ST1 agitator. Mix the composition at 200 RPM for 15 minutes at a temperature 25° C. Allow the aqueous coating composition to rest for 24 hours.

For aqueous coating compositions with Michem® Lube 511, add to the second polymer particles 1.0 weight/weight percent of the Michem® Lube 511, on a wet basis, and mix in a Heidolph ST1 agitator at low speed (10 rpm) for 10 minutes at room temperature. Mix 75 volume percent of the first polymer particle and 25 volume percent of the second polymer particle with the Michem® Lube 511, on a dry basis of the aqueous coating composition, in a Heidolph ST1 agitator. Mix the composition at 200 RPM for 15 minutes at a temperature 25° C. Allow the aqueous coating composition to rest for 24 hours.

To test the water absorption for each aqueous coating composition, centrifuge the aqueous coating composition at 2,000 RPM for 10 minutes in a Col Parmer 17341 centrifuge to remove air from the latex. Form a 1.2 millimeter (mm) thick coating of the aqueous coating composition on a glass plate with a U-shaped draw down bar from Byk-Gardner. Allow the aqueous coating composition to dry at a temperature 25° C. and a controlled relative humidity of 50% for seven (7) days to form the elastomeric coating. Remove the elastomeric coating from the glass plate and cut a 5 cm by 5 cm test specimen.

Weigh the test specimen using an analytic balance and record the initial weight in grams. Place the specimen in a glass beaker filled with tap water and allow the specimen to soak at room temperature for 24 hours. At 24 hours, remove the test specimen from the tap water and dry the surface of the test specimen with a paper tissue. Immediately weigh the specimen and record the final weight in grams. Repeat this 24 hour testing procedure and final weight measurements so as to complete 96 hours of soaking in the tap water. Calculate the percent water absorption with the following equation:

% Water Absorption=[(Final Weight−Initial Weight)/Initial Weight]×100

The results are shown in Table 8, below.

TABLE 8

| Aqueous Coating | Water |
|---|---|
| Composition prepared | Absorption after 96 hrs. |
| With Michem ® Lube 511 | 9% |
| w/o Michem ® Lube 511 | 15% |

As shown, the aqueous coating composition including the Michem® Lube 511 had a much lower percentage of water absorption after 96 hours. In paint formulations that use the aqueous coating composition as a binder, the use of a wax emulsion, like Michem® Lube 511, may help to provide a rough skin surface that is even more hydrophobic as compared to not using the wax emulsion in the paint formulation.

### Example 10

In this example, prepare four paint formulations each having a 42% PVC as described in Example 5, where the first paint formulation uses the aqueous coating composition as the binder (prepared as described in Example 5), the second paint formulation uses the aqueous coating composition as the binder (prepared as described in Example 5) with Michem® Lube 511 (1 weight/weight percent on a wet basis as described in Example 9), the third paint formulation uses UCAR® Latex DA 3176 A as the binder, and the fourth paint formulation uses RHOPLEX™ 2438 (Rhom and Haas) as the binder. Test the coatings formed with the paint formulations for elongation, tensile strength, water absorption, and vapor transmission.

To test elongation, tensile strength, water absorption and vapor transmission of the coatings, form a coating with each of the paint formulations by forming a 1.2 millimeter (mm) thick coating of the paint formulation on a glass plate with a U-shaped draw down bar from Byk-Gardner. Allow the paint formulation to dry at a temperature 25° C. and a controlled relative humidity of 50% for seven (7) days to form the coating. For the elongation and tensile strength, remove the coating from the glass plate and measure the elongation and the tensile strength of the coating according to ASTM D2370 using an Instron 1011 (Instron). Measure water absorption for the coating, as discussed herein, and vapor transmission according to ASTM F1249. The results are shown in Table 9, below.

TABLE 9

| | | | | Vapor |
|---|---|---|---|---|
| | | Tensile | | Transm. |
| | | [gram | Water | [gram/ |
| Paint Formulated with | Elongation | (force)/ | Absorption | m² · |
| 42% PVC | [%] | mm²] | [%] | day] |
| w/o Michem ® Lube 511 | 956 | 95 | 15 | 14.2 |
| with Michem ® Lube 511 | 981 | 92 | 8.2 | 8.6 |
| with UCAR ® Latex | 1120 | 85 | 12.9 | 11.5 |
| DA 3176 A as the Binder | | | | |
| with RHOPLEX ™ 2438 | 657 | 101 | 7.5 | 18.8 |

### Example 11

In this example, prepare four paint formulations each having a 27% PVC as described in Example 5, where the first paint formulation uses the aqueous coating composition as the binder (prepared as described in Example 5), the second paint formulation uses the aqueous coating composition as the binder (prepared as described in Example 5) with Michem® Lube 511 (1 weight/weight percent on a wet basis as described in Example 9), the third paint formulation uses UCAR® Latex DA 3176 A as the binder, and the fourth paint formulation uses RHOPLEX™ 2438 (Rhom and Haas) as the binder.

To test elongation, tensile strength, water absorption and vapor transmission of the coatings, form a coating with each of the paint formulations by forming a 1.2 millimeter (mm) thick coating of the paint formulation on a glass plate with a U-shaped draw down bar from Byk-Gardner. Allow the paint formulation to dry at a temperature 25° C. and a controlled relative humidity of 50% for seven (7) days to form the coating. For the elongation and tensile strength, remove the coating from the glass plate and measure the elongation and the tensile strength of the coating according to ASTM D2370 using an Instron 1011 (Instron). Measure water absorption for the coating, as discussed herein, and vapor transmission according to ASTM F1249. The results are shown in Table 10, below.

TABLE 10

| | | Tensile | | Vapor |
|---|---|---|---|---|
| | | [gram | Water | Transm. |
| Paint Formulated with | Elongation | (force)/ | Absorption | [gram/m² · |
| 27% PVC | [%] | mm²] | [%] | day] |
| w/o Minchem ® | 1434 | 70 | 16 | 12.2 |
| Lube 511 | | | | |
| with Michem ® | 1471 | 67 | 9.2 | 8.1 |
| Lube 511 | | | | |
| with UCAR ® Latex | 1680 | 63 | 13.4 | 10.8 |
| DA 3176 A as the Binder | | | | |
| with RHOPLEX ™ 2438 | 985 | 75 | 9 | 16.1 |

### Example 12

In this example, prepare four paint formulations: a first paint formulation having a 42% PVC using the same paint formulation described in Example 5, a second paint formulation having a 42% PVC using the same paint formulation described in Example 5a third paint formulation having a 42% PVC of using the same paint formulation described in Example 5 where and UCAR® Latex DA 3176 A is the binder; and a fourth paint formulation having a 27% PVC using the same paint formulation described in Example 5 where RHOPLEX™ 2438 (Rhom and Haas) is the binder.

For the Soiling Test, form an elastomeric coating with each of the paint formulations compositions by applying a 0.007 inch (7 mils) thick coat of the paint formulation to the varnished side of a Leneta Form 2C Opacity Chart (Leneta Company) using a U-shaped draw down bar from Byk-Gardner (USA). Allow the paint formulation to dry at a temperature 25° C. and a controlled relative humidity of 50% for 24 hours to form the coating.

Measure and record an initial reflectance of each coating using a Technibrite Micro TB-1C (measurement angle of 45° using a 457 nm wavelength). Soil the entire surface of the coating with a slurry of iron oxide in water (50% weight/weight slurry of red iron oxide and water) using a brush at a temperature of 25° C. Place the soiled coating in an oven (Blue M Industrial Oven) set to 60° C. for 8 hours. Allow the soiled coating to cool to room temperature. Wash the soiled coating with high pressure water (tap water at room temperature) using an air pistol (Cane NT) working at pressure of 40 PSI and at a distance of 20 to 30 cm from the soiled coating. Dry the washed soiled coating at room temperature and humidity. Repeat this soiling process a total of 5 times.

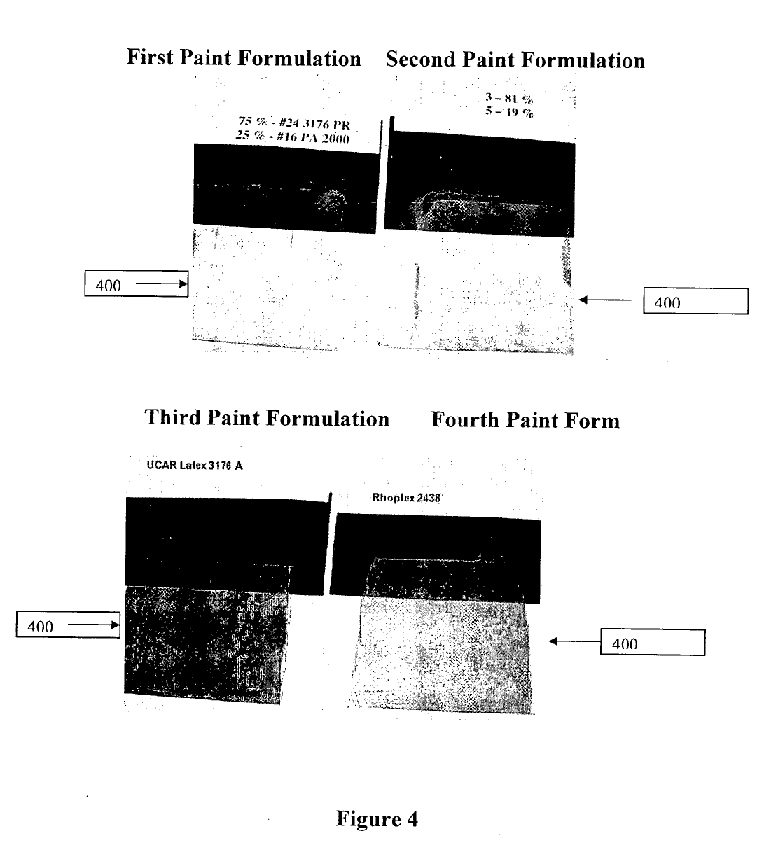

FIG. 4 provides images of the coatings after the Soiling Test, where the reflectance is measured in a region 400 of the soiled coatings that have been washed as discussed above. For the images, the dark portions in the region 400 indicate the presence of soil on the coatings. As can be seen, a visual comparative evaluation demonstrates that the elastomeric coatings formulated with the aqueous coating composition as the binder (the first and second paint formulations) provides superior dirt pickup resistance as compared to the other two coatings (the third and fourth paint formulations).

### Example 13

In this example, prepare a paint formulation having a 42% PVC, as discussed above for Example 5. Form a coating with the paint formulation by applying a 0.007 inch (7 mils) thick coat of the paint formulation to a Leneta P121-10N chart (Leneta Company) using a U-shaped draw down bar U from Byk-Gardner. Allow the paint formulation to dry at a temperature 25° C. and a controlled relative humidity of 50% for 24 hours to form the elastomeric coating. Measure contact angle for the coating using a Dataphysics OCA 150 according to ASTM D7334 (Pendant drop method).

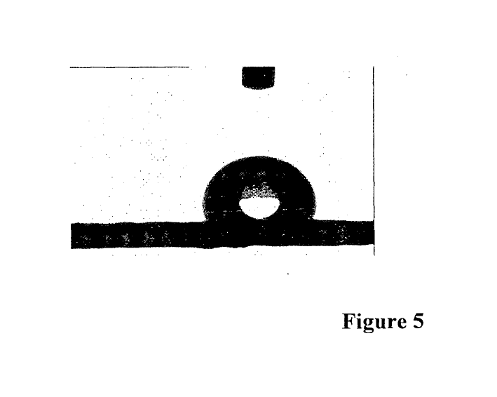

The elastomeric coating produces a contact angle of 142° degrees. FIG. 5 shows a picture of a drop of water on the elastomeric coating, whose shape indicates that the surface of the elastomeric coating is hydrophobic.

1. An aqueous coating composition, comprising:
a first polymer particle having a first volume average particle diameter and a Tg of −50° C. to −30° C.; and
a second polymer particle having a second volume average particle diameter and a Tg of 45° C. to 90° C., where a particle diameter ratio of the first volume average particle diameter to the second volume average particle diameter is at least 4:1.

2. The aqueous coating composition of claim 1, where the particle diameter ratio of the first volume average particle diameter to the second volume average particle diameter is in the range of 4:1 to 6:1.

3. The aqueous coating composition of claim 1, where the first volume average particle diameter is in the range of 0.33 micrometer to 0.60 micrometer and the second volume average particle diameter is in the range of 0.06 micrometer to 0.09 micrometer.

4. The aqueous coating composition of claim 1, where the first polymer particle and the second polymer particle each have a polydispersity index of no greater than 1.11.

5. The aqueous coating composition of claim 1, where the particle diameter ratio of the first volume average particle diameter to the second volume average particle diameter provide a percolation threshold volume (Vp) when the aqueous coating composition has at least 75 volume percent of the first polymer particle on a dry basis of the aqueous coating composition.

6. The aqueous coating composition of claim 1, where at least 75 volume percent of the particles are the first polymer particle on a dry basis.

7. The aqueous coating composition of claim 1, where the first polymer particle and the second polymer particle each include a hydrophobic branched monomer in polymerized form.

8. The aqueous coating composition of claim 7, where the hydrophobic branched monomer in the first polymer particle is isodecyl methacrylate (IDMA).

9. The aqueous coating composition of claim 7, where the hydrophobic branched monomer in the second polymer particle is vinyl neodecanoate (NEO 10).

10. The aqueous coating composition of claim 1, where the first polymer particle includes in polymerized form from 5 percent to 10 percent, by weight, of NEO 10, 3 percent or less, by weight, of a methyl methacrylate monomer, with the remaining monomer being 2-ethyl hexyl acrylate, or n-butyl acrylate or a combination thereof.

11. The aqueous coating composition of claim 1, where the first polymer particle includes a surfactant having a critical micelle concentration of less than 0.009 g/100 g in 0.1M NaCl at 25° C.

12. The aqueous coating composition of claim 1, where the second polymer particle includes an anionic paraffin/polyethylene wax emulsion.

13. The aqueous coating composition of claim 1, where the hydrophobic branched monomer in the second polymer particle is 2,2,2 trifluoromethacrylate.

14. An elastomeric coating formed with the aqueous coating composition of claim 1.

15. A method to improve dirt pick up resistance in an elastomeric coating comprising forming an elastomeric coating comprising the aqueous coating composition of claim 1.
